(19) United States
(12) Patent Application Publication
(10) Pub. No.: US 2005/0046955 A1
(43) Pub. Date: Mar. 3, 2005

(54) Optical pickup device comprising achromatic prism

(75) Inventors: Hee-Dong Kim, Kyunggi-Do (KR); Cheol-Sung Yeon, Kyunggi-Do (KR); Ju-Young Gong, Seoul (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/734,199

(22) Filed: Dec. 15, 2003

(30) Foreign Application Priority Data
Aug. 27, 2003 (KR) 2003-59575

(51) Int. Cl. G02B 27/12

(52) U.S. Cl. 359/640

(57) ABSTRACT

Disclosed is an optical pickup device, which comprises a twin LD (Laser Diode) and an achromatic prism for compensating for optical axes, thereby omitting a separate optical component such as an HOE (Holographic Optical Element) or a wedge beam splitter and having a simple optical pickup structure. The optical pickup device includes a light emitting element for emitting two or more light beams having different wavelengths; an objective lens for converging the light beams emitted from the light emitting element onto an optical disk; a light receiving element for receiving light beams reflected by the optical disk; a beam splitter installed at an optical route between the light emitting element and the objective lens; and an achromatic prism installed at an optical route between the light emitting element and the beam splitter.

### BACKGROUND OF THE INVENTION

1. Field of the Invention

The present invention relates to an optical pickup device, and more particularly to an optical pickup device, which comprises a twin LD (Laser Diode) and an achromatic prism for compensating for optical axes, thereby omitting a separate optical component such as an HOE (Holographic Optical Element) or a wedge beam splitter and thus having a simple optical pickup structure.

2. Description of the Related Art

Generally, a DVD (Digital Versatile Disc) player is a device for reproducing DVDs, and is manufactured so that it can reproduce both CDs and DVDs in consideration of compatibility between the CDs and DVDs.

In order to reproduce both CDs and DVDs, a conventional optical pickup device adapts a laser diode (hereinafter, referred to as a “LD”) for CDs and an LD for DVDs as light sources, thus being complicated in structure, being large in its number of components, and being increased in production cost.

Accordingly, in order to decrease the number of the components of the optical pickup device and miniaturize the optical pickup device, the optical pickup device has been recently developed to employ a twin LD in which an LD chip for CDs and an LD chip for DVDs are combined into a single package instead of respective LDs for CDs and DVDs serving as light sources for CDs and DVDs.

Since the LD for CDs and the LD for DVDs within one package of the twin LD are separated from each other by a distance of approximately 150 μm, axes of light beams emitted from the LD for CDs and the LD for DVDs do not coincide.

In case that a photodetector and other optical elements are arranged in the conventional optical pickup device comprising the twin LD such that they fit in the optical axis of one light beam of the above two light beams, the other light beam of the two light beams passing through a collimator lens deviates from its optical axis. Thereby, the shape of this light beam on the disk is distorted, thus causing deterioration of signal reproduction quality. Further, the light beam is not focused on the photodetector, thus causing a difficulty in normally detecting an optical signal.

Accordingly, the optical pickup device employing the twin LD generally requires a separate component for compensating for the optical axes of the above two light beams so that the axes coincide. Thus, in order to compensate for the optical axes, the conventional optical pickup device employing the twin LD must further comprise an optical component such as a wedge beam splitter or an HOE (Holographic Optical Element).

FIG. 1 is a schematic view of a conventional optical pickup device. The conventional optical pickup device comprises a twin LD 11 for CDs and DVDs, an objective lens 23 for converging light beams emitted from the twin LD 11 onto an optical disk (D), and a light receiving element 25 for receiving light beams reflected by the optical disk (D).

Here, non-described reference numeral 17 represents a diffraction grating, and non-described reference numeral 21 represents a collimator lens.

In order to compensate for the difference between optical axes of the two light beams in the above-described conventional optical pickup device, a double plate beam splitter 19 for arranging a reproduced light beam 13a for CDs (hereinafter, referred to as a “first light beam”) and a reproduced light beam 15a for DVDs (hereinafter, referred to as a “second light beam”), which have different wavelengths and are emitted from the twin LD 11, in one line is installed on an optical route between the twin LD 11 and the collimator lens 21.

The double plate beam splitter 19 includes a first plane 19a for mainly reflecting the first light beam 13a, which is coated with a DVD reflection layer, and a second plane 19b for mainly reflecting the second light beam 15a, which is coated with a CD reflection layer.

Hereinafter, function of the above-described conventional optical pickup device will be described in detail. The first light beam 13a emitted from a first light source 13 is incident onto the first plane 19a of the beam splitter 19 at an angle of 45 degrees, and then mostly reflected such that the reflected portion of the first light beam 13a is transferred to the objective lens 23.

The second light beam 15a emitted from a second light source 15 is incident onto the first plane 19a of the beam splitter 19 at an angle of 45 degrees, refracted at a designated angle, and then mostly reflected at the second plane 19b of the beam splitter 19. The reflected portion of the second light beam 15a is incident again onto the first plane 19a of the beam splitter 19, and then transferred to the objective lens 23.

The above-described conventional optical pickup device employs a method for compensating for optical axes, in which the optical axis of the emitted first light beam 13a and the optical axis of the emitted second light beam 15a coincide by adjusting the refractivity and thickness of the first plane 19a of the beam splitter 19.

However, since the double plate beam splitter 19 of the above conventional optical pickup device has an ultra thin thickness, the allowable error of the thickness is limited, thereby causing a difficulty of manufacturing the beam splitter 19.

That is, since the thickness of the beam splitter 19 is ultra thin, a very small error in the thickness of the beam splutter 19 may cause the optical axes of the two light beams to deviate from desired values.

Instead of the above double plate beam splitter 19, as shown in FIG. 2, the conventional optical pickup device may comprise a wedge beam splitter (BS) 20. The wedge beam splitter 20 includes a first plane 20a for reflecting the first light beam 13a, and a second plane 20b for reflecting the second light beam 15a. The first plane 20a and the second plane 20b are connected to each other at a designated angle.

The first light beam 13a emitted from the first light source is incident onto the first plane 20a of the wedge beam splitter 20, and then mostly reflected such that the reflected portion of the first light beam 13a is transferred to the objective lens 23. Further, the second light beam 15a emitted from the second light source is incident onto the first plane 20a of the wedge beam splitter 20, refracted at a designated angle, and then mostly reflected at the second plane 20b of the wedge beam splitter 20. The reflected portion of the second light beam 15a is incident again onto the first plane 20a of the beam splitter 20, and then transferred to the objective lens 23.

Since the wedge beam splitter 20 also has an ultra thin thickness, the allowable error of the thickness is limited and the angle of the wedge beam splitter 20 must be adjusted under the condition of the ultra thin thickness, thereby causing a difficulty of manufacturing the wedge beam splitter 20.

FIG. 3 is a schematic view of a conventional optical pickup device comprising a twin LD and an HOE (Holographic Optical Element). As shown in FIG. 3, this conventional optical pickup device comprises a twin LD 32 for emitting a light beam for CDs and a light beam for DVDs, an HOE 34 including two or more holographic patterns for respectively diffracting the light beams for CDs and DVDs, a collimator lens 40, an objective lens 42 for converging the light beams for CDs and DVDs onto a track of the optical disk (D), and a light receiving element 36 for receiving light beams diffracted by the HOE 34.

The HOE 34 is fixedly installed on the upper surface of a package 38.

Here, non-described reference numeral 37 represents an opening of the package 38.

In the above conventional optical pickup device, when the light beam for CDs and the light beam for DVDs, reflected by the optical disk (D), pass through the patterns formed on the upper surface of the HOE 34, the light beams are diffracted by the patterns for respectively diffracting the light beams and the diffracted light beams are converged into one point on the light receiving element 36 through the opening 37. Thereby, the optical pickup is achieved.

However, the above conventional optical pickup device requires the HOE 34, which is expensive and has a complicated manufacturing process, thus increasing its production cost.

As described above, in order to compensate for the optical axes of the light beams, the conventional optical pickup device employing the twin LD must further comprise a separate optical component such as the double plate beam splitter 19, the wedge beam splitter 20, or the HOE 34. It is difficult to manufacture such an optical component, thereby increasing the production cost of the optical pickup device and an expense taken to pick up light beams.

Further, in case that the conventional optical pickup device employing the twin LD does not comprise any separate optical component such as the double plate beam splitter 19, the wedge beam splitter 20 or the HOE 34, optical axes do not coincide on the entire optical routes of light emitting and receiving portions. Accordingly, in this case, the conventional optical pickup device does not comprise the light receiving element 25 reacting to both the light beams for CDs and DVDs as shown in FIG. 1, but comprises a light receiving portion including a two-wavelength photo diode IC (PDIC) 50, in which two light receiving elements respectively reacting to a light beam for CDs and a light beam for DVDs are separated by a distance as much as the difference between the optical axes of the light beams for CDs and DVDs, thus having a disadvantage in that the optical pickup device cannot be miniaturized.

As described above, since the conventional optical pickup device using the twin LD further requires the separate optical component for allowing the optical axes to coincide, or the two-wavelength photo diode IC, it is difficult to achieve goals of producing an optical pickup device with a low production cost and a thin profile.

In order to solve the above problems, there is proposed a conventional optical pickup device for compensating for optical axes without application of any additional optical component.

In accordance with Korean Patent Laid-open No. 2003-19957, as shown in FIGS. 5 and 6, a prism 52, formed in an isosceles triangle, which includes first and second planes 52a and 52b sloping at the same angle to the optical axes and a third plane 52c being perpendicular to the optical axes, is installed on an optical route between a light source 51 and a beam splitter 53.

In the above conventional optical pickup device comprising the prism 52, a first light beam 55a and a second light beam 56a, which are emitted from the light source 51, are incident onto the first and second planes 52a and 52b at the same angle in parallel, are refracted at the first and second planes 52a and 52b at different angles, and are then emitted from the second plane 52c under the condition that optical angles of the first and second light beams 55a and 56a coincide.

After the first and second light beams 55a and 56a having the coinciding optical axes are reflected by the beam splitter 53, the reflected first and second light beams 55a and 56a pass through the collimator lens 57 and the objective lens 58 sequentially, and then converged onto the optical disk (D) serving as a recording medium.

The first and second light beams 55a and 56a, which are reflected by the optical disk (D), pass through the above-described process in the opposite direction, and are then received by a photodetector 59.

The above application states that the first and second light beams 55a and 56a, which are emitted from the light source 51, are incident onto the first and second planes 52a and 52b at the same angle in parallel, are refracted at the first and second planes 52a and 52b at different angles, and then emitted from the third plane 52c under the condition that the optical angles of the first and second light beams 55a and 56a coincide. However, since the above application does not specifically teach a method for allowing the optical axes of the first and second light beams 55a and 56a having different wavelengths, which are refracted at different angles, to coincide, it is difficult to substantially obtain the coincidence of the optical axes. Further, the above application states, as shown in FIG. 6, that incidence angles (θ₁ and θ_{1′}) and refraction angles (θ₂ and θ_{2′}) are made equal by adjusting an angle α of the isosceles triangular prism 52 in which angles α and α′ of the isosceles triangular prism 52 are the same, and then the difference between optical axes of the first and second light beams 55a and 56a can be easily compensated. However, a light beam for CDs and a light beam for DVDs have different wavelengths, thus having different refraction angles in the same material of the prism. Accordingly, it is difficult to cause optical axes of the light beam for CDs and the light beam for DVDs to coincide with each other using the isosceles triangular prism.

### SUMMARY OF THE INVENTION

Therefore, the present invention has been made in view of the above problems, and it is an object of the present invention to provide a low-cost or ultra-thin optical pickup device comprising a twin LD, in which optical axes of lights having difference wavelengths coincide without application of any additional optical component such as a double plate beam splitter, a wedge beam splitter or an HOE, and a light pickup structure of the device is simplified.

In accordance with one aspect of the present invention, the above and other objects can be accomplished by the provision of an optical pickup device comprising: a light emitting element for emitting two or more light beams having different wavelengths; an objective lens for converging the light beams emitted from the light emitting element onto an optical disk; a light receiving element for receiving light beams reflected by the optical disk; a beam splitter installed at an optical route between the light emitting element and the objective lens; and an achromatic prism installed at an optical route between the light emitting element and the beam splitter.

Preferably, the achromatic prism may include a prism made of a flint glass, onto which the light beams are incident; and a prism made of a crown glass, from which the light beams incident onto the prism made of a flint glass are emitted, wherein: a front end surface of the prism made of a flint glass serves as a light incidence plane; a contact plane of the prism made of a flint glass and the prism made of a crown glass serves as a light refraction plane; a rear end surface of the prism made of a crown glass serves as a light emission plane; and the light beams having different wavelengths incident onto the front end surface of the prism made of a flint glass are refracted so that optical axes of the light beams coincide, and are then emitted from the rear end surface of the prism made of a crown glass.

Further, preferably, the beam splitter may be a flat beam splitter.

In accordance with another aspect of the present invention, there is provided an optical pickup device comprising: a light emitting element module including a light emitting element for emitting two or more light beams having different wavelengths, an achromatic prism installed in front of the light emitting element, and a holder for holding the light emitting element and the achromatic prism so that the light emitting element and the achromatic prism are combined into a single package; an objective lens for converging the light beams emitted from the light emitting element module onto an optical disk; a light receiving element for receiving light beams reflected by the optical disk; and a beam splitter installed at an optical route between the light emitting element module and the objective lens.

Preferably, the achromatic prism may include a prism made of a flint glass, onto which the light beams are incident; and a prism made of a crown glass, from which the light beams incident onto the prism made of a flint glass are emitted, wherein: a front end surface of the prism made of a flint glass serves as a light incidence plane; a contact plane of the prism made of a flint glass and the prism made of a crown glass serves as a light refraction plane; a rear end surface of the prism made of a crown glass serves as a light emission plane; and the light beams having different wavelengths incident onto the front end surface of the prism made of a flint glass are refracted so that optical axes of the light beams coincide, and are then emitted from the rear end surface of the prism made of a crown glass.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a conventional optical pickup device;

FIG. 2 is a schematic view of another conventional optical pickup device;

FIG. 3 is a schematic view of a conventional optical pickup device comprising an HOE (Holographic Optical Element);

FIG. 4 is a plan view of a photo diode IC employed by a light receiving portion of a conventional optical pickup device;

FIG. 5 is a schematic view of a conventional optical pickup device comprising a polygonal prism;

FIG. 6 is a schematic view illustrating optical axis compensation achieved through the polygonal prism in FIG. 5;

FIG. 7 is a schematic view of an optical pickup device in accordance with an embodiment of the present invention;

FIG. 8 is a schematic view of a conventional prism;

FIG. 9 is a schematic view of a conventional achromatic prism;

FIG. 10 is a schematic view of an achromatic prism in accordance with the present invention; and

FIG. 11 is a schematic view of a package using the achromatic prism in accordance with an embodiment of the present invention.

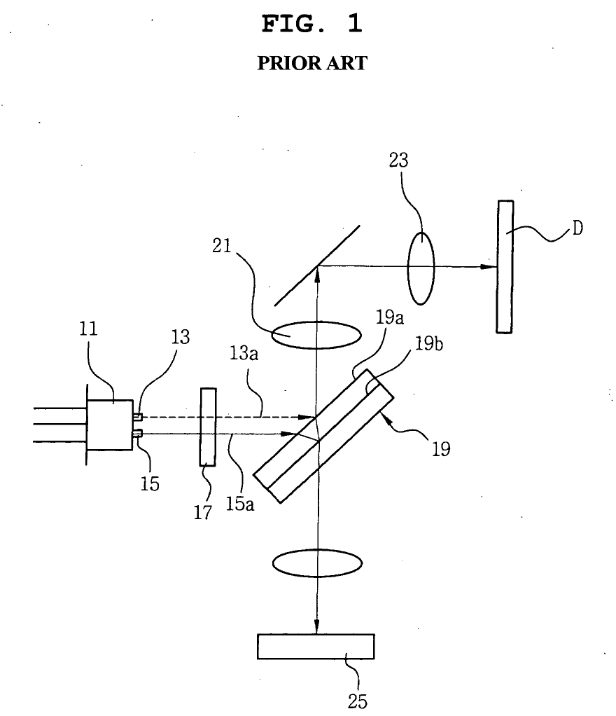

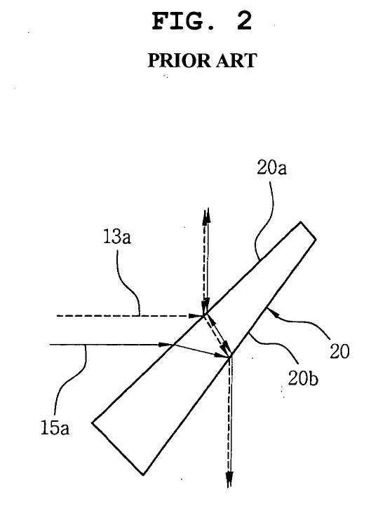

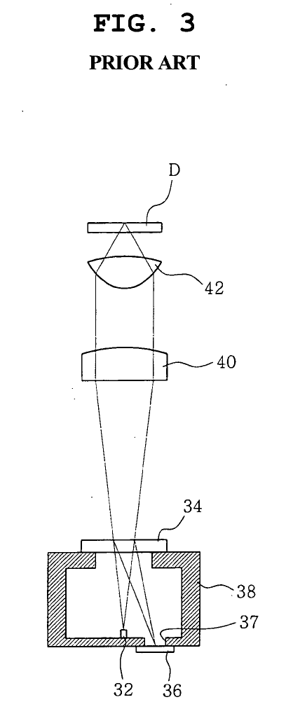

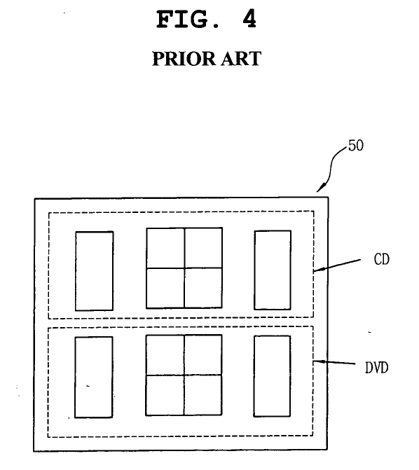

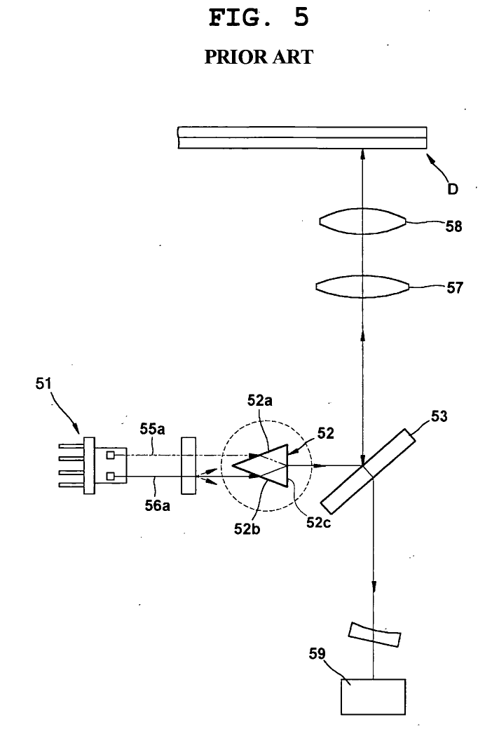

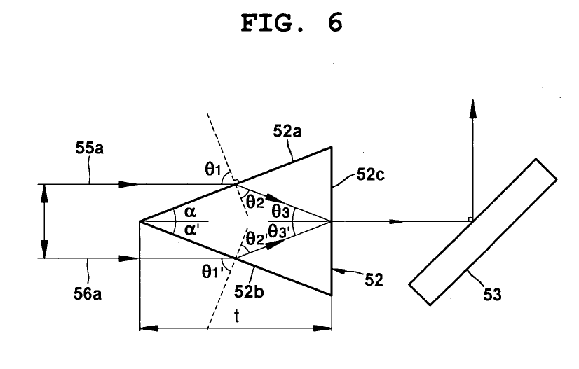

### DESCRIPTION OF THE PREFERRED EMBODIMENTS

Now, preferred embodiments of the present invention will be described in detail with reference to the annexed drawings.

An optical pickup device of the present invention comprises a light emitting element emitting two or more light beams having different wavelengths, and an achromatic prism, installed at an optical route between the light emitting element and a beam splitter, for causing incident light beams having different wavelengths to be refracted so that optical axes of the light beams coincide.

The achromatic prism of the optical pickup device of the present invention has a structure opposite to that of a conventional achromatic prism. That is, a light emission plane in the conventional achromatic prism is adapted as a light incidence plane in the achromatic prism of the optical pickup device of the present invention so that light beams having different wavelengths emitted from the light emitting element are incident in parallel onto the achromatic prism, refracted to designated angles and then emitted from the achromatic prism under the condition that optical axes of the light beams coincide.

Here, a multi-wavelength light source for emitting three or more wavelength light beams such as a light beam for CDs, a light beam for DVDs and a blue-ray, or a twin LD such as a two-wavelength light source for emitting a light beam for CDs and a light beam for DVDs is used as the light emitting element.

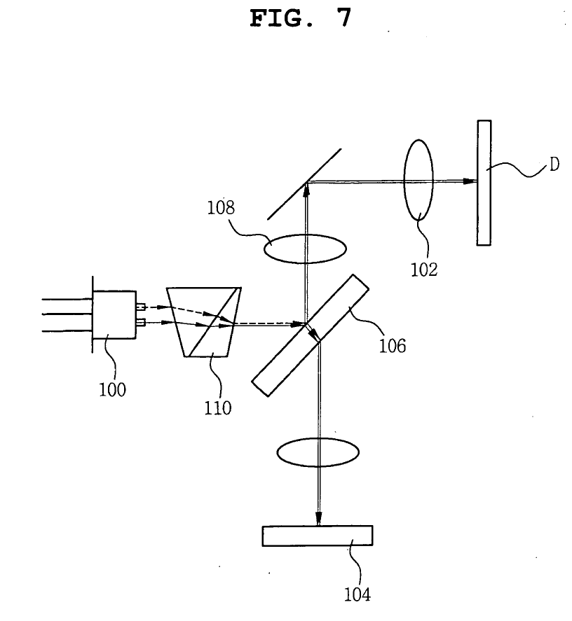

FIG. 7 is a schematic view of an optical pickup device in accordance with an embodiment of the present invention. The optical pickup device comprises a light emitting element 100 for emitting at least two light beams having different wavelengths, an objective lens 102 serving to converge the light beams emitted from the light emitting element 100 onto an optical disk (D), and a light receiving element 104 for receiving light beams reflected by the optical disk (D). A beam splitter 106 is installed at an optical route between the light emitting element 100 and the objective lens 102, and a collimator lens 108 for collimating light beams, of which route is converted by the beam splitter 106, is installed adjacent to the beam splitter 106.

In accordance with an embodiment of the present invention, a twin LD, serving as a two-wavelength light source, for emitting light beams for CDs and DVDs is adapted as the light emitting element 100. A multi-wavelength light source emitting three or more light beams, such as light beams for CDs, DVDs and a blue-ray, may be adapted as the light emitting element 100. Accordingly, the light emitting element 100 is not limited to the above-described twin LD or the multi-wavelength light source.

Further, a conventional flat beam splitter is adapted as the beam splitter 106.

Here, an achromatic prism 110 for causing optical axes of lights to coincide is installed on an optical route between the light emitting element 100 and the beam splitter 106 in the optical pickup device of the present invention.

The achromatic prism 110 is manufactured by combining two prisms, which are made of a material suitable for removing dispersion of light beams, or have vertical angles respectively.

Generally, when light beam pass through a prism, which is made of one material, the light beam is refracted and goes in a direction at a designated angle to incident direction, and simultaneously has different deviation angles according to wavelengths of the light. Accordingly, the light beam is dispersed. As shown in FIG. 8, in case that n represents refractivity of a material of a thin prism having small angles and refractivity of air is 1, a deviation angle (D) of incident light beam is defined by an equation of D=I₁+I400 ₂−A=A(n−1) , and a dispersion (dD) of incident light beam is defined by another equation of

$$dD = D \frac{dn}{( n - 1 )} = \frac{D}{V} .$$

However, when the light beam passes through an assembly produced by combining two prisms made of different materials using suitable vertical angles, the light beam passing through the prism assembly is refracted but is not dispersed. The selection of the materials of the two prisms is determined by ABBE No., which represents variation of refractivity expressed by the rate of the velocity of light beam in vacuum and the material and variation of refractivity according to wavelengths. ABBE No. (V) to a d ray (587.6 nm) is defined by an equation of

$$V = \frac{{n}_{d} - 1}{{n}_{F} - {n}_{c}} .$$

F and C rays respectively have wavelengths of 486.1 nm and 656.3 nm. Generally, a crown glass has an ABBE No. of more than 50, and a flint glass has an ABBE No. of less than 50.

The achromatic prism, as well known to those skilled in the art, is produced by combining a prism made of a flint glass having small dispersion with a rear portion of a prism made of a crown glass having large dispersion. By using the above achromatic prism, when two light beams having different wavelengths are incident onto one optical axis, the two light beams are emitted in parallel without light dispersion. In order to eliminate dispersion of the two light beams and coincide deviation angles of the two light beams, the following conditions must be satisfied.

$$\begin{matrix}Deviation {D}_{1 , 2} = {D}_{1} = {D}_{2} = {A}_{1} ( {n}_{1} - 1 ) = {A}_{2} ( {n}_{2} - 1 ) \\ Dispersion {dD}_{1 , 2} = {dD}_{1} + {dD}_{2} = \frac{{A}_{1} ( {n}_{1} - 1 )}{{V}_{1}} + \frac{{A}_{2} ( {n}_{2} - 1 )}{{V}_{2}} = 0\end{matrix}$$

Here, subscripts 1 and 2 represent prisms made of a crown glass and a flint glass, respectively. From the above conditions, the vertical angles of the two prisms are defined by the following equations.

$$\begin{matrix}{A}_{1} = \frac{{D}_{1 , 2} {V}_{1}}{( {n}_{1} - 1 ) ( {V}_{1} - {V}_{2} )} \\ {A}_{2} = \frac{{D}_{1 , 2} {V}_{2}}{( {n}_{2} - 1 ) ( {V}_{2} - {V}_{1} )}\end{matrix}$$

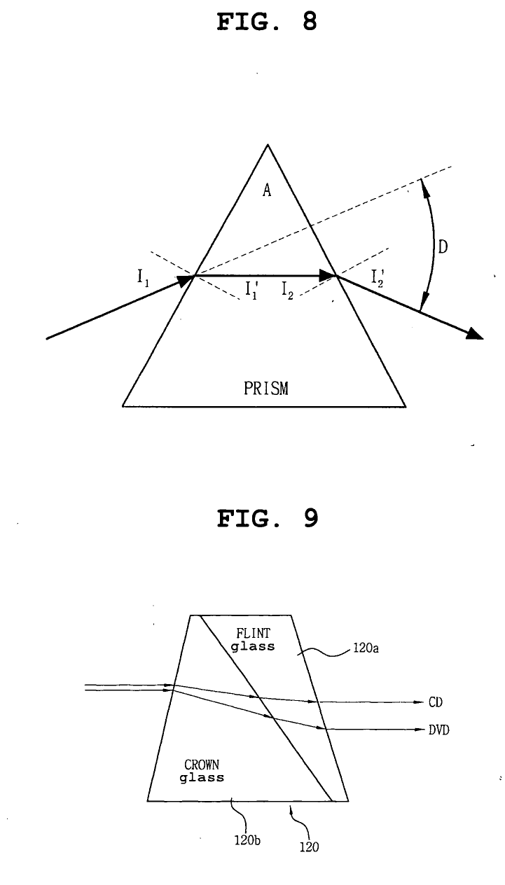

FIG. 9 is a schematic view of a conventional achromatic prism 120. As shown in FIG. 9, in an optical pickup device employing the conventional achromatic prism 120 comprising two prisms respectively having vertical angles A₁ and A₂, two light beams having different wavelengths are incident onto the achromatic prism 120 through a prism 120b made of a crown glass having a larger refractivity, and are then emitted from the achromatic prism 120 through another prism 120a made of a flint glass having a smaller refractivity, so that the two light beams are emitted in parallel without light dispersion. More specifically, the incident light beams pass through the prism 120b made of a crown glass so that the light beams are refracted to a high degree, and then pass through the prism 120a made of a flint glass so that the light beams are refracted again. Thereby, the light beams having parallel angles are emitted in parallel from the achromatic prism 120.

That is, when light beams having different wavelengths for CDs and DVDs are incident onto the conventional achromatic prism 120, light beams are refracted as shown by an arrow in FIG. 8, sequentially pass through the prism 120b made of a crown glass and the prism 120a made of a flint glass, and are then emitted from the achromatic prism 120 under the condition that the light beams are parallel with each other.

An achromatic prism in accordance with the present invention uses an opposite sequence of the above-described process of the conventional achromatic prism 120.

That is, as shown in FIG. 10, an achromatic prism 110 in accordance with the present invention is produced by combining a prism 110b made of a crown glass with a rear surface of a prism 110a made of a flint glass. A front end surface 111 of the prism 110a made of a flint glass serves as a light incidence plane, a contact plane 112 of the prism 110a made of a flint glass and the prism 110b made of a crown glass serves as a light refraction plane, and a rear end surface 113 of the prism 110b made of a crown glass serves as a light emission plane. Whenever light beams having different wavelengths incident onto the prism 110a made of a flint glass pass through the respective prisms 110a and 110b, the light beams are refracted such that optical axes of the light beams coincide with each other, and are then emitted from the achromatic prism 110 through the rear surface 113 of the prism 110b made of a crown glass.

In other words, the achromatic prism 110 of the present invention comprises two prisms installed in an opposite sequence of the conventional achromatic prism 120. Accordingly, when two parallel light beams having different wavelengths and optical axes are incident onto the achromatic prism 110, the two light beams are emitted from the achromatic prism 110 under the condition that the light beams have the same optical axes without light dispersion.

Here, the achromatic prism 110 is produced by combining the prism 110a made of a flint glass and the prism 110b made of a crown glass in consideration of refraction angles of light beams for CDs and DVDs, so that the light beams for CD and DVDs have the same optical axis after passing through the prism 110a and the prism 110b.

The coincidence of the optical axes of the light beams having different wavelengths in the achromatic prism 110 of the present invention is resulted from the opposite process of the refraction of light beams in the conventional achromatic prism 120, and may be obtained by other various embodiments.

Hereinafter, function and effects of an optical pickup device employing the achromatic prism 110 of the present invention will be described in detail.

First, the light emitting element 100 emits light beams for CDs or DVDs.

Since the achromatic prism 110 is installed in front of the light emitting element 100, the emitted light beams for CDs or DVDs are incident onto the prism 110a made of a flint glass.

Here, the light beams incident onto the front end surface 111 of the prism 110a made of a flint glass are refracted at the prism 110a made of a flint, refracted again at the contact plane 112 of the prism 110a made of a flint glass and the prism 110b made of a crown glass, and are then finally refracted at the rear end surface 113 of the prism 110b made of a crown glass when the light beams are emitted from the rear end surface 113.

Since the achromatic prism 110 of the present invention is produced by combining the prism 110a made of a flint glass and the prism 110b made of a crown glass in consideration of refraction angles of light beams for CDs and DVDs, a light beam for CDs and a light beam for DVDs incident onto the front end surface 111 of the prism 110a made of a flint glass, as shown in FIG. 10, pass through the prism 110a made of a flint glass and the prism 110b made of a crown glass, thereby having the same optical axis and being emitted from the achromatic prism 110.

Thereafter, the light beams for CDs and DVDs emitted from the achromatic prism 10 are transferred to the collimator lens 108 through the beam splitter 106 for converting routes of the light beams. Then, the light beams, which pass through the collimator lens 108 and are collimated, are converged into the objective lens 102, and then transferred to the optical disk (D).

The light beams reflected by the optical disk (D) sequentially pass through the objective lens 102, the collimator lens 108 and the beam splitter 106, and is then received by the light receiving element 104.

Here, the light beams emitted from the light emitting element 100 pass through the achromatic prism 110, thereby having the same optical axes. Accordingly, both a light beam for CDs and a light beam for DVDs are received by the light receiving element 104 through the same optical route, thus allowing the optical pickup device in accordance with the present invention not to require any additional optical component.

That is to say, since the optical pickup device of the present invention employs the achromatic prism 110 having a opposite structure of the conventional achromatic prism 120, in case that two light beams having different optical axes and wavelengths, which are arranged in parallel, are incident onto the achromatic prism 110, the light beams are converted into light beams having the same optical axis and then emitted from the achromatic prism 110 without light dispersion. Accordingly, the achromatic prism 110 is arranged at the rear of the twin LD so that two light beams having different axes emitted from the twin LD coincide, thereby allowing the optical pickup device to have a simple structure the same as a conventional optical pickup device using either a LD for CDs or a LD for DVDs.

Further, in accordance with another embodiment of the present invention, the above-described achromatic prism can be combined with a light emitting element and packaged into a single component.

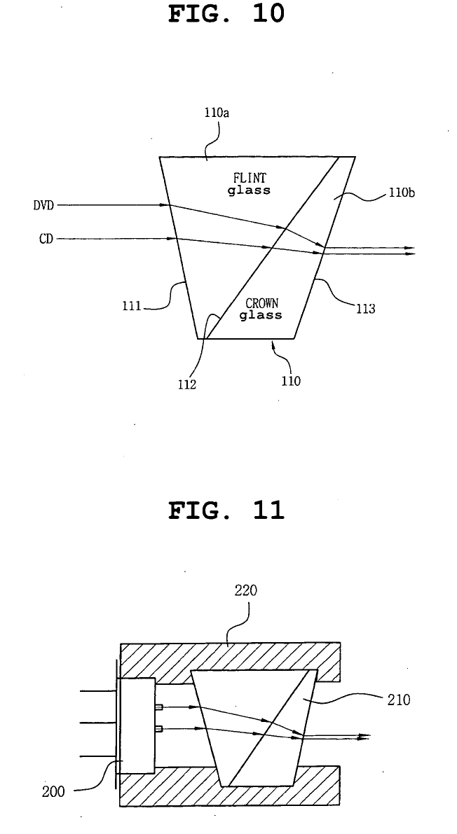

FIG. 11 is a schematic view of a package comprising a twin LD 200 and an achromatic prism 210 using a holder 220. As shown in FIG. 11, an optical pickup device comprises a light emitting element module including a light emitting element 200 serving as the twin LD for emitting two or more light beams having different wavelengths, the achromatic prism 210 installed in front of the light emitting element 200, and the holder 220 for holding the light emitting element 200 and the achromatic prism 210, so that the light emitting element 200 and the achromatic prism 210 are combined into a single package.

The above optical pickup device further comprises an objective lens for converging the two or more light beams having different wavelengths emitted from the light emitting element module into an optical disk, a light receiving element for receiving light beams reflected by the optical disk, and a beam splitter installed at an optical route between the light emitting element module and the objective lens.

Here, the achromatic prism 210 includes a prism made of a flint glass, onto which the light beams are incident, and a prism made of a crown glass, from which the light beams incident onto the prism made of a flint glass are emitted. Further, the achromatic prism 210 of this embodiment has the same constitution and function as, those of the achromatic prism 110 of the earlier embodiment of the present invention.

The optical pickup device in accordance with this embodiment of the present invention comprises the single package including the light emitting element 200 and the achromatic prism 210, thus having a simple structure.

That is, the above optical pickup device comprising the single package including the light emitting element 200 and the achromatic prism 210 combined with each other using the holder 220 can more easily achieve an optical pickup system.

As apparent from the above description, the present invention provides an optical pickup device, which comprises a twin LD (Laser Diode) and an achromatic prism for compensating for optical axes of respective light beams emitted from two light sources without light dispersion, thereby allowing the optical axes of the light beams to coincide.

The achromatic prism of the present invention unites two optical axes of light beams emitted from the twin LD into a single optical axis without application of any separate optical component such as an HOE (Holographic Optical Element) or a wedge beam splitter, thus causing the optical pickup device to have a simple optical pickup structure the same as that of a conventional optical pickup device comprising an LD for CDs or an LD for DVDs.

Accordingly, it is possible to manufacture a low-cost or ultra-thin optical pickup device.

Further, the present invention provides a light emitting element module comprising a light emitting element and an achromatic prism in a single package, thereby simplifying an optical pickup system. Moreover, it is possible to obtain a good signal of a light receiving portion only by adjusting the light emitting module.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An achromatic prism comprising:
a prism made of a flint glass, onto which two or more light beams having different wavelengths are incident; and
a prism made of a crown glass, from which the light beams incident onto the prism made of a flint glass are emitted, wherein:
a front end surface of the prism made of a flint glass serves as a light incidence plane;
a contact plane of the prism made of a flint glass and the prism made of a crown glass serves as a light refraction plane;
a rear end surface of the prism made of a crown glass serves as a light emission plane; and
the light beams having different wavelengths incident onto the front end surface of the prism made of a flint glass are refracted so that optical axes of the light beams coincide, and are then emitted from the rear end surface of the prism made of a crown glass.

2. A light emitting element module comprising:
a light emitting element for emitting two or more light beams having different wavelengths;
an achromatic prism installed in front of the light emitting element; and
a holder for holding the light emitting element and the achromatic prism so that the light emitting element and the achromatic prism are combined into a single package.

3. The light emitting element module as set forth in claim 2, wherein the achromatic prism comprises:
a prism made of a flint glass, onto which the light beams are incident; and
a prism made of a crown glass, from which the light beams incident onto the prism made of a flint glass are emitted, wherein:
a front end surface of the prism made of a flint glass serves as a light incidence plane;
a contact plane of the prism made of a flint glass and the prism made of a crown glass serves as a light refraction plane;
a rear end surface of the prism made of a crown glass serves as a light emission plane; and
the light beams having different wavelengths incident onto the front end surface of the prism made of a flint glass are refracted so that optical axes of the light beams coincide, and are then emitted from the rear end surface of the prism made of a crown glass.

4. An optical pickup device comprising:
a light emitting element for emitting two or more light beams having different wavelengths;
an objective lens for converging the light beams emitted from the light emitting element onto an optical disk;
a light receiving element for receiving light beams reflected by the optical disk;
a beam splitter installed at an optical route between the light emitting element and the objective lens; and
an achromatic prism installed at an optical route between the light emitting element and the beam splitter.

5. The optical pickup device as set forth in claim 4, wherein the achromatic prism comprises:
a prism made of a flint glass, onto which the light beams are incident; and
a prism made of a crown glass, from which the light beams incident onto the prism made of a flint glass are emitted, wherein:
a front end surface of the prism made of a flint glass serves as a light incidence plane;
a contact plane of the prism made of a flint glass and the prism made of a crown glass serves as a light refraction plane;
a rear end surface of the prism made of a crown glass serves as a light emission plane; and
the light beams having different wavelengths incident onto the front end surface of the prism made of a flint glass are refracted so that optical axes of the light beams coincide, and are then emitted from the rear end surface of the prism made of a crown glass.

6. The optical pickup device as set forth in claim 4, wherein the beam splitter is a flat beam splitter.

7. An optical pickup device comprising:
a light emitting element module including a light emitting element for emitting two or more light beams having different wavelengths, an achromatic prism installed in front of the light emitting element, and a holder for holding the light emitting element and the achromatic prism so that the light emitting element and the achromatic prism are combined into a single package;
an objective lens for converging the light beams emitted from the light emitting element module onto an-optical disk;
a light receiving element for receiving light beams reflected by the optical disk; and
a beam splitter installed at an optical route between the light emitting element module and the objective lens.

8. The optical pickup device as set forth in claim 7, wherein the achromatic prism comprises:
a prism made of a flint glass, onto which the light beams are incident; and
a prism made of a crown glass, from which the light beams incident onto the prism made of a flint glass are emitted, wherein:
a front end surface of the prism made of a flint glass serves as a light incidence plane;
a contact plane of the prism made of a flint glass and the prism made of a crown glass serves as a light refraction plane;
a rear end surface of the prism made of a crown glass serves as a light emission plane; and
the light beams having different wavelengths incident onto the front end surface of the prism made of a flint glass are refracted so that optical axes of the light beams coincide, and are then emitted from the rear end surface of the prism made of a crown glass.

9. The optical pickup device as set forth in claim 7, wherein the beam splitter is a flat beam splitter.
